(19) United States
(12) Patent Application Publication
(10) Pub. No.: US 2018/0346231 A1
(43) Pub. Date: Dec. 6, 2018

(54) ANIMAL FOOT COVER DISPENSER

(71) Applicant: Hannah YOO, Rancho Mirage, CA (US)

(72) Inventor: Hannah YOO, Rancho Mirage, CA (US)

(21) Appl. No.: 15/615,246

(22) Filed: Jun. 6, 2017

(51) Int. Cl. B65D 83/08; B65D 33/14; A01K 13/00

(52) U.S. Cl. CPC B65D 83/08; B65D 33/14; B65H 2701/19; A01K 13/006; A01K 13/007

(57) ABSTRACT

The invention comprises an animal foot cover dispenser and system, animal foot covers, and a method of use. The animal foot cover system comprises an animal foot cover dispenser and at least one animal foot cover configured to be loaded into the dispenser, placed on an animal's foot through the use of the dispenser, and dispensed from the dispenser.

### BACKGROUND OF THE INVENTION

The present invention relates to pet care. Specifically, this invention relates to a dispenser system configured to dispense animal foot covers.

Domesticated animals or pets rely on the use of their feet in order to walk, feel, and survive. In some climates, animals' feet are subjected to harsh environmental conditions that can leave the animals with severe tissue and nerve damage. An animal's foot may blister or crack when exposed to extremely hot or cold surfaces. The use of corrosive substances, such as salt, on surfaces can also lead to skin irritation and cracks on the animal's foot. Additionally, uncovered animal feet can lead to a spread of contaminants, infectious diseases, or allergic skin reactions on the animal's foot. The use of a cover over an animal's foot ensures that the foot is protected from extreme conditions and can also help the animal's owner more easily maintain foot cleanliness.

Typical animal foot covers consist of ‘shoes’ that the owner must fasten to the animal's feet via some configuration of straps or elastic. The process of attaching these covers to an animal's feet can be cumbersome and time-consuming for both the owner and the animal. Similarly, typical animal foot covers tend to be easily removable by the animal itself, or are altogether unwieldy for the animal while the foot is covered. Such difficulties have hindered the widespread use of animal foot covers by animal owners.

Additionally, in situations where there is an emergency need for the animal's feet to be covered, a few seconds of time can determine the difference between causing damage to an animal's feet or not. Similarly, where an animal is moments away from causing a mess or becoming dirty, a quick foot cover dispenser may assist the owner in reducing the amount and area of the mess.

The present invention seeks to provide solutions to the aforementioned issues surrounding the use of typical animal foot covers by providing a dispenser that enables an animal owner to quickly and efficiently attach covers to an animal's foot.

### SUMMARY OF THE INVENTION

The present invention is directed to an animal foot cover dispenser and system, animal foot covers, and a method of use. The animal foot cover system comprises an animal foot cover dispenser and at least one animal foot cover configured to be loaded into the dispenser, placed on an animal's foot through the use of the dispenser, and dispensed from the dispenser.

In one embodiment, the animal foot cover dispenser comprises a cover dispenser enclosure configured to receive and remove an animal's foot. The dispenser comprises a plurality of rail members coupled to the cover dispenser enclosure. The plurality of rail members configured in one portion to retain cover members within the cover dispenser enclosure and in another portion to release the cover member and animal's foot from the cover dispenser enclosure.

One embodiment of the animal foot cover dispenser comprises a cover dispenser enclosure bound by a top and bottom surface and at least one continuous sidewall. The top surface of the dispenser enclosure may comprise a lid member with an animal foot receiving opening dimensioned to accept an animal's foot. The continuous sidewall may comprise an animal foot dispensing opening disposed in one portion of the sidewall configured to facilitate the removal of a recently covered animal foot. The interior of the dispenser enclosure may comprise a plurality of rail members coupled to the cover dispenser enclosure and spanning the length of the dispenser enclosure. The plurality of rail members is configured to retain and guide cover members in one portion and stage and dispense the cover members in another portion. Each of the plurality of rail members further comprises an elongated portion and an impedance portion. The elongated portion extends towards a rear end of the dispenser and may be configured to retain and guide foot covers prior to being dispensed. The impedance structure of each of the plurality of rail members may be configured to guide and stage animal foot covers in preparation for being dispensed. The impedance structures of each of the plurality of rail members are configured such that rail members disposed parallel and mirrored to another will form a foot acceptance area partially bound by the impedance structures.

In some embodiments, an exterior surface of the dispenser enclosure may comprise ergonomic surface features configured to accommodate a user's hand and facilitate resting the dispenser on a surface.

In some embodiments, any exterior surface of the cover dispenser enclosure may comprise surface features configured to aid friction and gripping with a surface which the dispenser rests upon.

In some embodiments, the cover dispenser enclosure comprises a bottom surface and a rear surface wherein the plurality of rail members is coupled to the interior of the rear surface or the interior of the bottom surface.

In one embodiment, an end of each of the plurality of rail members comprises an additional retention member configured to retain animal foot covers within the interior of the device.

In one embodiment, the animal foot receiving opening aligns with the animal foot dispensing opening, forming a continuous opening for both insertion and removal of an animal's foot.

In one embodiment, the top surface of the dispenser comprises a lid member that is coupled to the dispenser enclosure via common mechanical attachment mechanisms including but not limited to a friction fitting, hinged mechanism, detent or snap fitting.

In one embodiment, the cover dispenser is coupled to a removable stand. The removable stand may be configured to provide stability to the system when resting on another surface.

It is to be understood by one of ordinary skill in the art that the dispenser enclosure of any of the embodiments described above may comprise a transverse cross-section shaped as including but not limited to a square, rectangle, polygon, circle, ellipse, irregular polygon, or a combination of the like.

An additional aspect of the invention comprises the animal foot covers. The animal foot covers comprise an enclosure bound by at least one continuous surface, manufactured from an industry-standard material such as, including but not limited to, rubber, latex, polyurethane, nitrile, polyethylene or polyester; and are further configured to enclose an animal foot.

In one embodiment, the animal foot covers may also comprise a plurality of holes configured to couple with the rail members of the dispenser.

In another embodiment, the animal foot covers may be removably coupled to one another and configured to be separated from one another through an application of sufficient force by a user.

In another embodiment, the animal foot covers may comprise a fastening system along a first opening, configured to facilitate coupling the animal foot cover to an animal's foot.

In another embodiment, the animal foot covers may further comprise a means to remove the foot cover from the animal's foot, including but not limited to perforations along the at least one continuous surface.

Another aspect of the invention comprises a method for dispensing an animal foot cover. The method for dispensing an animal foot cover comprises first loading the enclosure with at least one foot cover and then priming the dispenser by pulling the first cover forward and staging it in an open position within the foot acceptance area. An animal foot is then inserted into the dispenser enclosure and into the loaded animal foot cover, which is then removed along with a now-attached foot cover. The motion of removing the first animal foot cover and covered animal foot causes repriming of the dispenser by staging the next foot cover within the foot acceptance area.

The methods, systems, and apparatuses are set forth in part in the description which follows, and in part will be obvious from the description, or can be learned by the practice of the methods, apparatuses, and systems. The advantages of the methods, apparatuses, and systems will be realized and attained by means of the elements and combinations particularly pointed out in the appended claims. It is to be understood that both the foregoing general description and the following detailed description are exemplary and explanatory only and are not restrictive of the methods, apparatuses, and systems, as claimed. More details concerning these embodiments, and others, are further described in the following figures and detailed description set forth herein below.

### BRIEF DESCRIPTION OF THE DRAWINGS

In the accompanying figures, like elements are identified by like reference numerals among the several preferred embodiments of the present invention.

FIG. 1 is a perspective view of the animal foot cover dispenser and animal foot cover system.

FIG. 2 is a perspective view of the animal foot cover dispenser.

FIG. 3A is a perspective view of the animal foot cover dispenser with the top surface partially exploded away to view the interior rail members.

FIG. 3B is an exploded view of the animal foot cover dispenser.

FIG. 4 is a perspective view of the animal foot covers.

FIG. 5A is an exploded view of the animal foot cover dispenser.

FIG. 5B is a perspective view of the removed rail members of the animal foot cover partially loaded with animal foot covers.

FIG. 5C is a perspective view of the removed rail members of the animal foot cover loaded with animal covers.

FIG. 5D is an exploded view of the animal foot cover dispenser system, with animal foot cover loaded onto the rail members.

FIG. 6 is a perspective view of the animal foot cover dispenser with the top surface partially exploded away to give a clear view of the interior rail members holding a plurality of foot covers, just after a foot cover has been dispensed.

FIG. 7 is a perspective view of the animal foot cover dispenser with the top surface partially exploded away to view the interior rail members holding a plurality of foot covers, with one cover in a position ready to be dispensed.

FIG. 8 is a perspective view of the animal foot cover dispenser and animal foot cover system during operation, with a first animal foot cover being dispensed and a second animal foot cover being staged, repriming the animal foot cover dispenser for a second use.

While the invention has been described in connection with various embodiments, it will be understood that the invention is capable of further modifications. This application is intended to cover any variations, uses or adaptations of the invention following, in general, the principles of the invention, and including such departures from the present disclosure as, within the known and customary practice within the art to which the invention pertains.

### DETAILED DESCRIPTION OF THE PREFERRED EMBODIMENTS

The foregoing and other features and advantages of the invention will become more apparent from the following detailed description of exemplary embodiments, read in conjunction with the accompanying drawings. The detailed description and drawings are merely illustrative of the invention rather than limiting, the scope of the invention being defined by the appended claims and equivalents thereof.

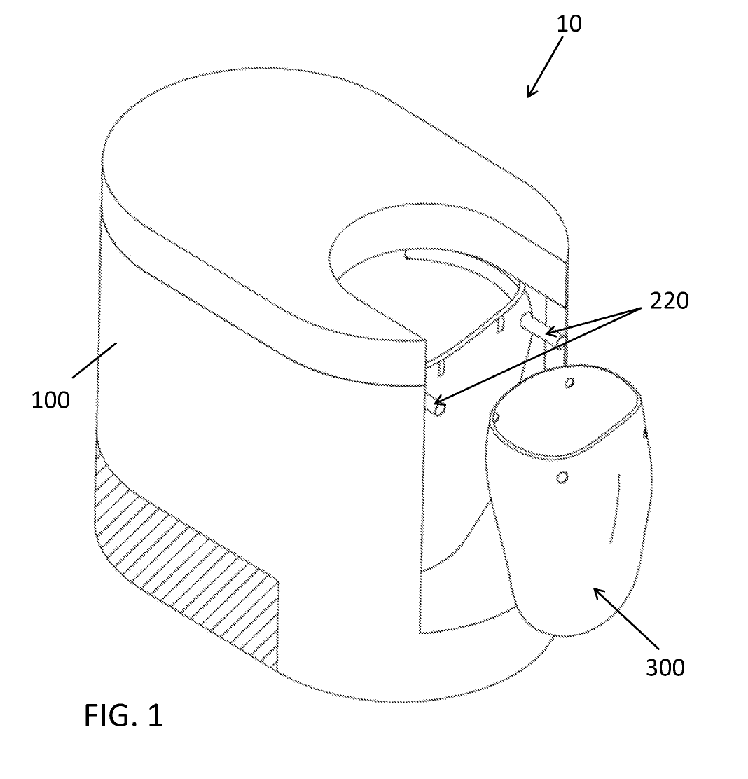

The animal foot cover dispenser system 10 is represented in FIG. 1, comprising a dispenser 100 having a plurality of rail members 220 disposed within and a plurality of animal foot covers 300 disposed upon and guided by the rail members 220. The system 10 is configured to dispense animal foot covers 300 onto an animal's foot by preloading and priming the dispenser 100 with animal foot covers 300, inserting the animal's foot into the dispenser 100 and an animal foot cover 300, then removing the now-covered animal foot and repriming the dispenser 100 with the next animal foot cover 300.

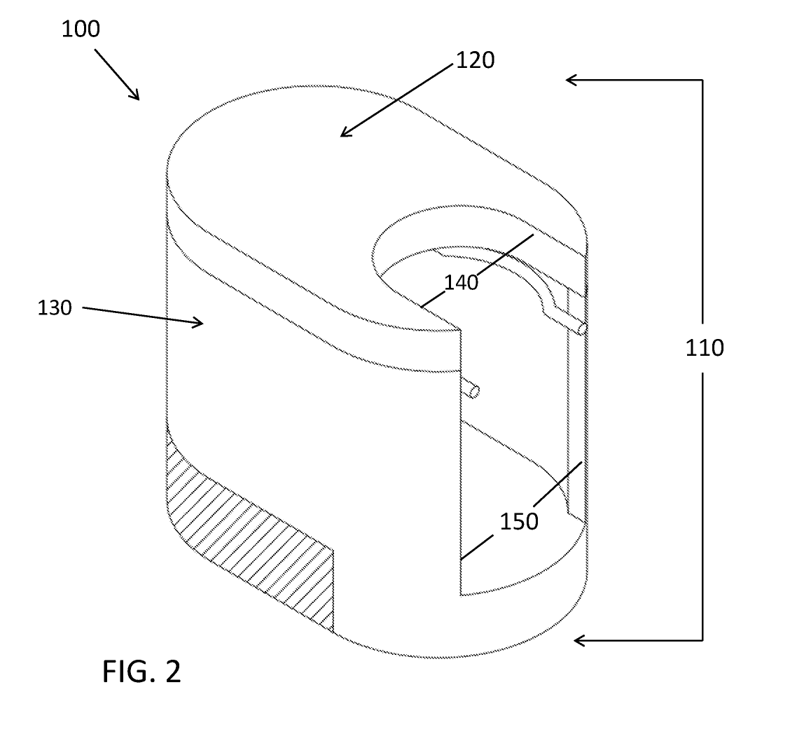

FIG. 2 illustrates a perspective view of one embodiment of an animal foot cover dispenser 100 comprising a dispenser enclosure 110 defined by a top surface 120, bottom surface (not shown), and at least one sidewall 130. In some configurations, the top surface 120 is unbounded, forming an animal foot receiving opening 140, dimensioned to receive an animal's foot. In other configurations, the top surface 120 comprises a lid member 120 having an opening that forms the animal foot receiving opening 140. The sidewall 130 may further comprise a animal foot dispensing opening 150 dimensioned to accommodate an animal's foot. In some configurations, the bounds of the animal foot dispensing opening 150 coincide with the bounds of the animal foot receiving opening 140 to form a continuous opening extending from the top surface 120 to the sidewall 130.

The animal foot cover dispenser enclosure 110 may be comprised of a material known to those of ordinary skill in the art, including but not limited to, plastics, metals, or wood. A person of ordinary skill in the art would appreciate that the cross-sectional shape of the dispenser enclosure 110 may be various geometric shapes including but not limited to rectangles, polygons, irregular polygons, circles, and ellipses. A person of ordinary skill in the art would further appreciate that the animal foot cover dispenser 100 may be configured in any orientation, and that terms such as “sidewall” and “exterior surface” may encompass other terms such as “top surface” and “bottom surface.”

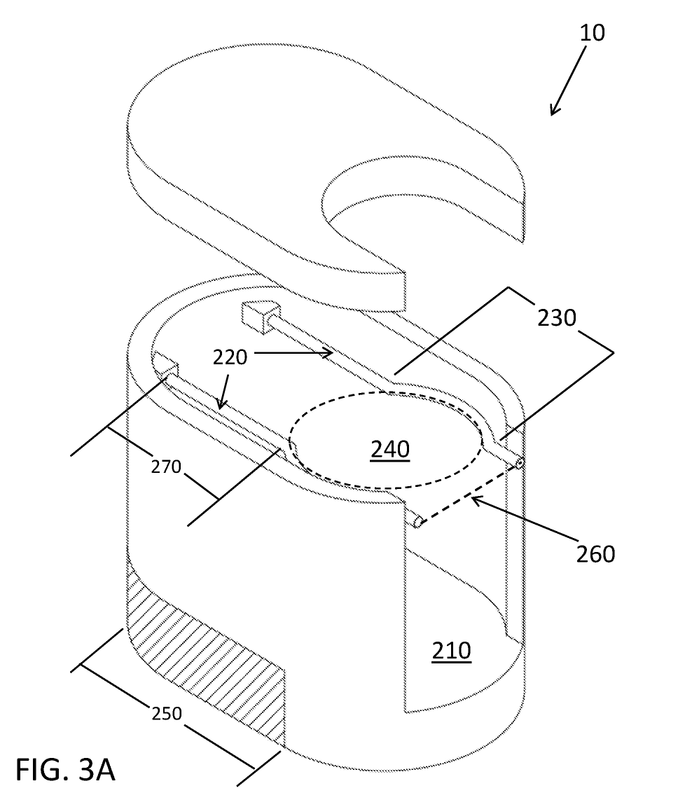

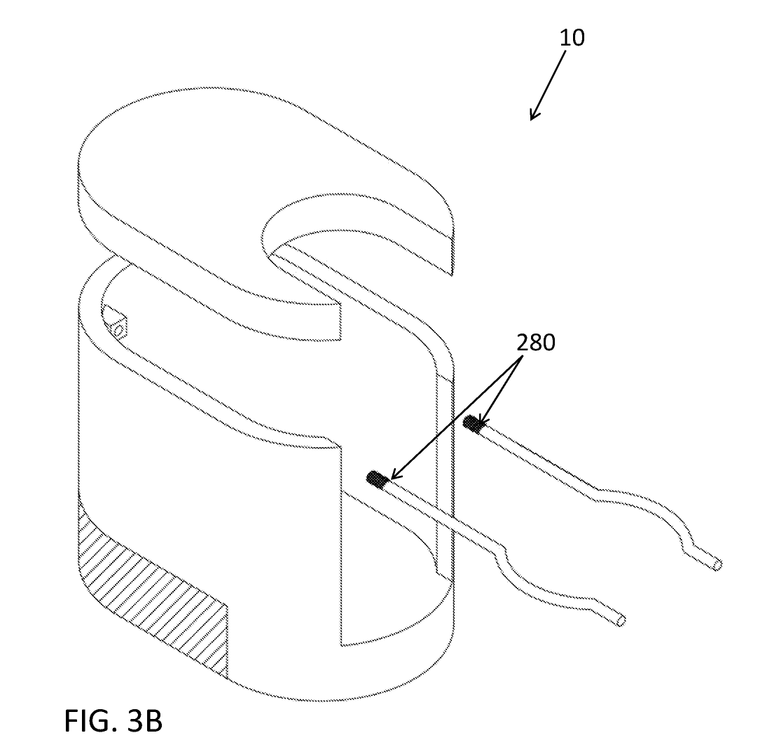

FIGS. 3A and 3B illustrate the interior 210 of the dispenser enclosure 110 formed by the top 120 and bottom surfaces and the sidewall 130, further comprising a plurality of rail members 220 coupled to the enclosure 110 and spanning the length of the dispenser enclosure 110. Each of the plurality of rail members 220 further comprises an elongated portion 270 and an impedance structure portion 230. Additionally, the elongated portion 270 is configured to retain and guide animal foot covers 300 prior to being dispensed. The impedance structure portion 230 is configured to impede foot covers 300 from leaving the elongated portion 270 of the rail member 220 without the additional aid of a pulling force on the foot cover 300. Once an animal foot cover 300 is pulled and stretched around the impedance structure 230, the impedance structure 230 is configured to act as a guide to stage animal foot covers 300 in preparation for being dispensed. The impedance structures 230 of each of the plurality of rail members 220 are configured such that rail members 220 disposed parallel and mirrored to another will form a foot acceptance opening 240. The foot acceptance opening 240 is partially bound by the mirrored impedance structures 230 and also forms an animal foot release opening 260 for the covered animal foot to exit the device. The rail members 220 may be manufactured from any industry standard material, including but not limited to metal or plastic. The rail members 220 may also be manufactured from the same industry standard material as the dispenser enclosure 110, and may be molded thereto. In another embodiment shown in FIG. 3B , an end of each of the plurality of rail members 220 may further comprise a coupling feature 280, including but not limited to threading, friction fitting, or keyed fitting, such that the rail members 220 may be removably coupled to the dispenser enclosure 110.

In another embodiment of the animal foot cover dispenser 100, an exterior surface of the sidewall 130 may comprise ergonomic surface features 250, including but not limited to grooved, ribbed, or rubberized sections. The ergonomic surface features 250 may further comprise shapes to assist a user in gripping the dispenser 100 with either hand, enabling hand-held operation.

In another embodiment, an exterior surface of the dispenser enclosure 110 may comprise an enhanced frictional finish to facilitate a surface grip between the exterior surface and a surface on which it rests, conferring overall stability to the dispenser 100. The enhanced frictional finish may also be configured to facilitate further hand-held operation by a user. The enhanced frictional finish may include, but is not limited to, grooved, ribbed, or patterned surfaces and may comprise rubberized sections.

In another embodiment of the animal foot cover dispenser 100, each of the plurality of rail members 220 may comprise an additional retention member (not shown) coupled to the impedance structure portion 230, facilitating retention of animal foot covers 300 within the dispenser 100. The retention members may be coupled to the rail members 220 such that the retention members are under appropriate tension as to apply a force on the animal foot covers 300 within the dispenser 100, yet still allowing the removal of a recently covered animal appendage. The retention members may be movably coupled to the rail members 220 via mechanical hinge, molded hinge, spring, or any other movable attachment system known to those of ordinary skill in the art.

In another embodiment of the invention, some bounds of the animal foot receiving opening 140 and the animal foot dispensing opening 150 may coincide to form a continuous opening spanning a portion of the top surface 120 and a portion of the sidewall 130 of the dispenser enclosure 110. The continuous opening may be configured such that the opening provides immediate access to the foot acceptance area 240 disposed within the enclosure 110. Access to the foot acceptance area 240 enables an animal's foot to be inserted through the animal foot receiving opening 140 of the top surface 120, disposed through the foot acceptance area 240 containing an open animal foot cover 300, and the recently covered foot to be removed from the dispenser 100 through the animal foot dispensing opening 150.

In another embodiment of the dispenser 100, the top surface 120 comprises a lid member 120 coupled to the enclosure 110. A person of ordinary skill in the art would appreciate that the lid member 120 may be removable or attached to the enclosure via a hinge, spring, frictional fitting, latch or other appropriate fastening mechanism. In another embodiment of the invention, the animal foot cover dispenser 100 comprises a removable base (not shown) coupled with the dispenser enclosure 110 via friction fit.

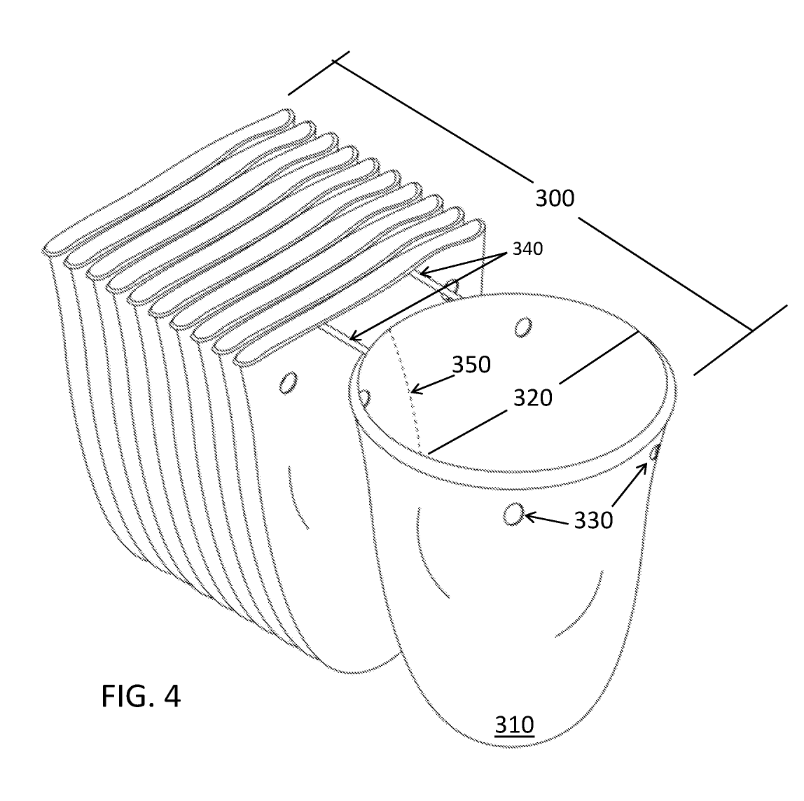

The animal foot covers 300 of FIG. 4 may comprise at least one continuous surface 310, configured to form a first opening 320 through which an animal foot may be inserted. The animal foot covers 300 may be manufactured from an industry-standard material such as, including but not limited to, polyethylene, polyester, or an elastomer such as rubber, latex, or polyurethane; and are further configured to enclose an animal foot. The animal foot covers 300 may also comprise a plurality of holes 330, disposed through the surface 310 of the animal foot covers 300, configured to couple with the plurality of rail members 220 of the dispenser 100. The animal foot covers 300 may be coupled to other covers 300 by way of a coupling material 340. The coupling material 340 may be configured to decouple from an animal foot cover 300 through an application of sufficient force by a user. It will be appreciated by those of ordinary skill in the art that the coupling material 340 may be made of any suitable industry-standard material, whether it is the same or different from the industry-standard material which comprises the animal foot covers 300. The animal foot covers 300 may also comprise a fastening mechanism disposed along the first opening 320, such as elastic or pull-string cinching mechanisms, configured to couple the animal foot cover 300 to the animal's foot. The animal foot covers 300 may also comprise a means to remove the foot cover from the animal's foot, such as perforations 350 along a portion of the at least one continuous surface 310. The perforations 350 may be configured to allow uncoupling of the at least one continuous surface 310 by application of a sufficient force, such that the animal foot cover 300 may be removed from the animal foot by a user.

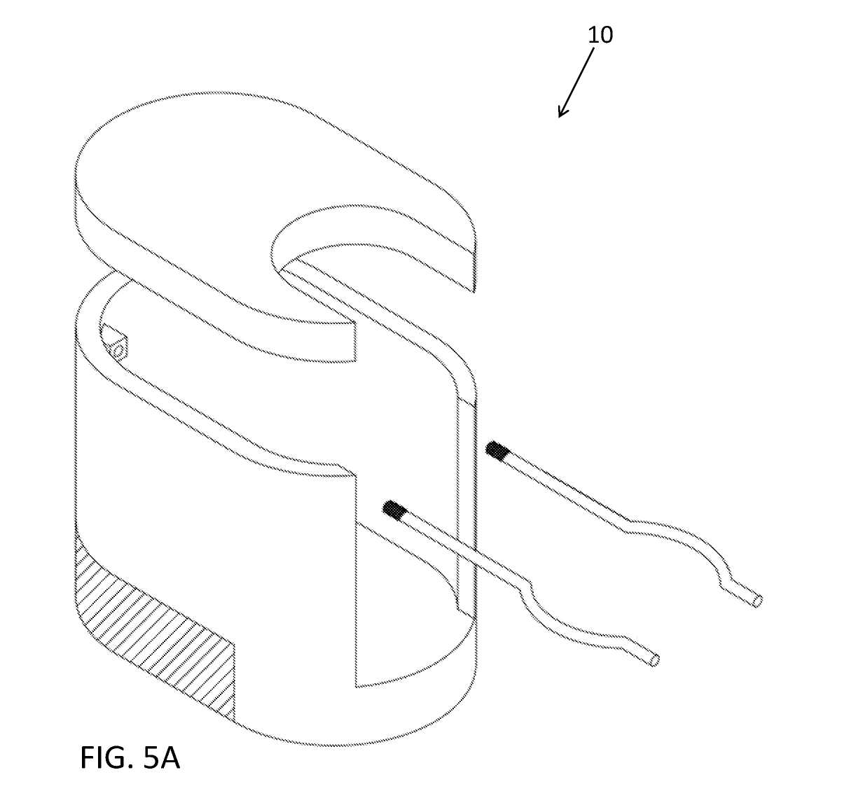

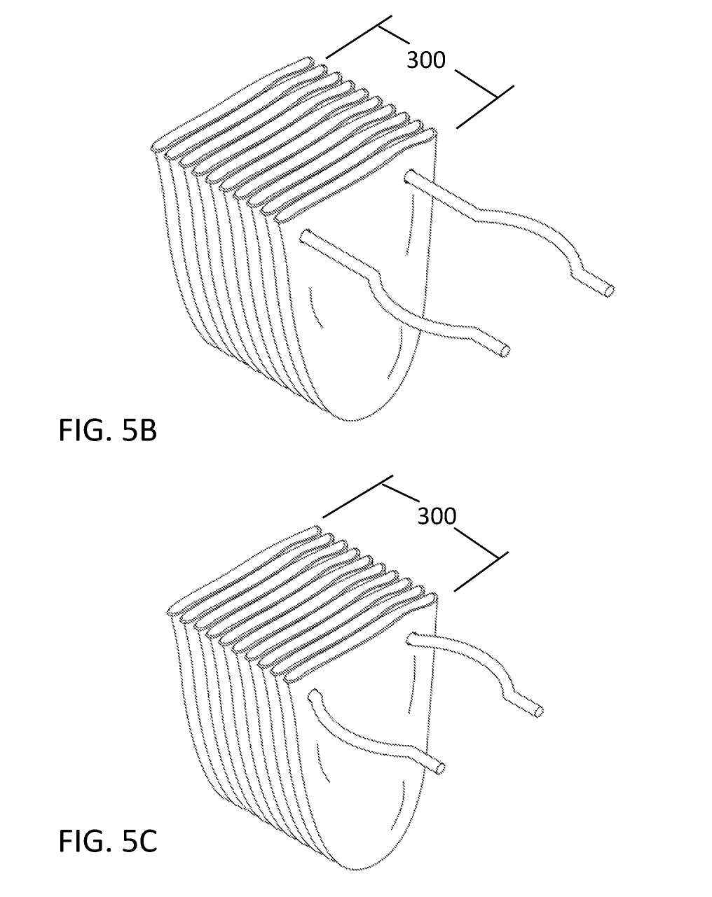

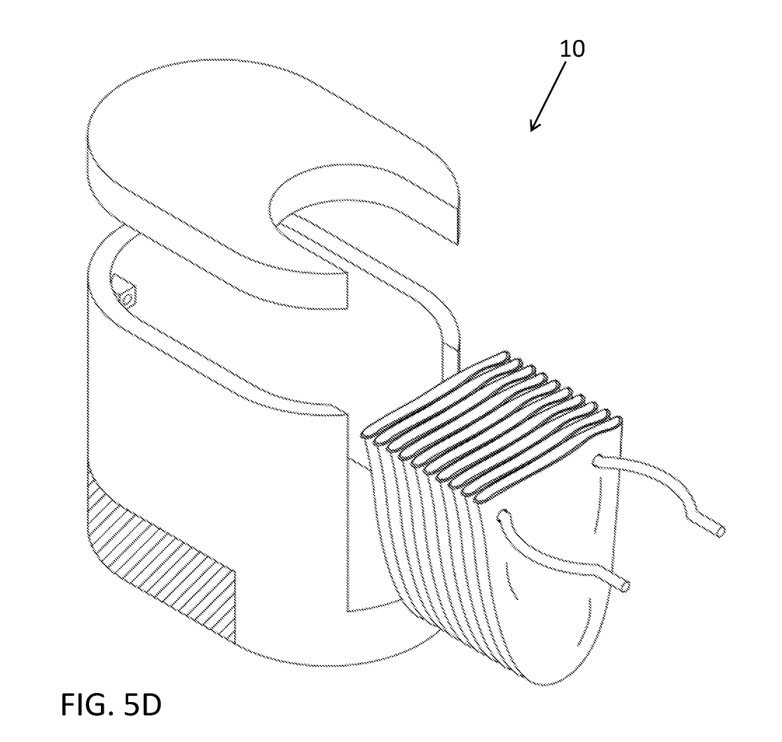

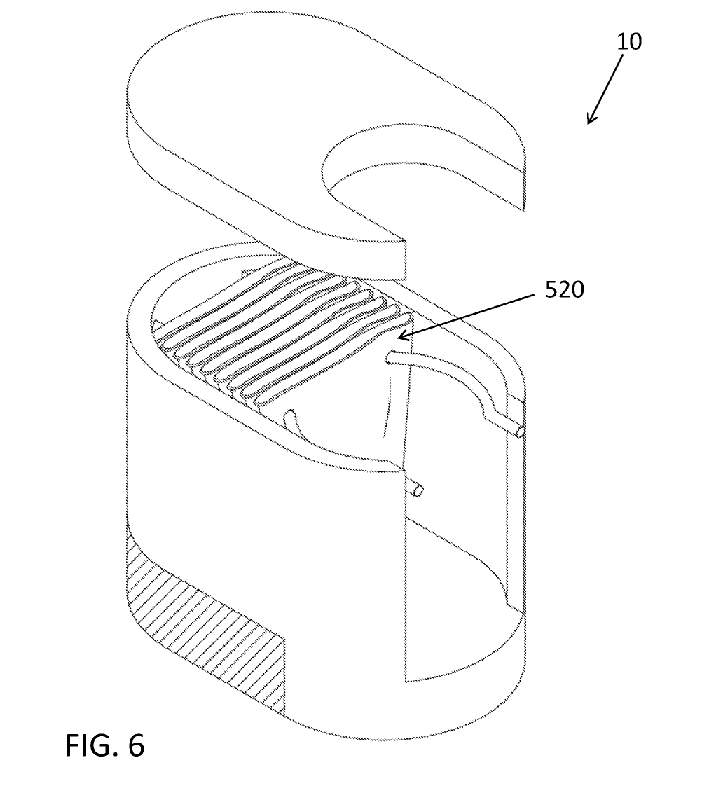

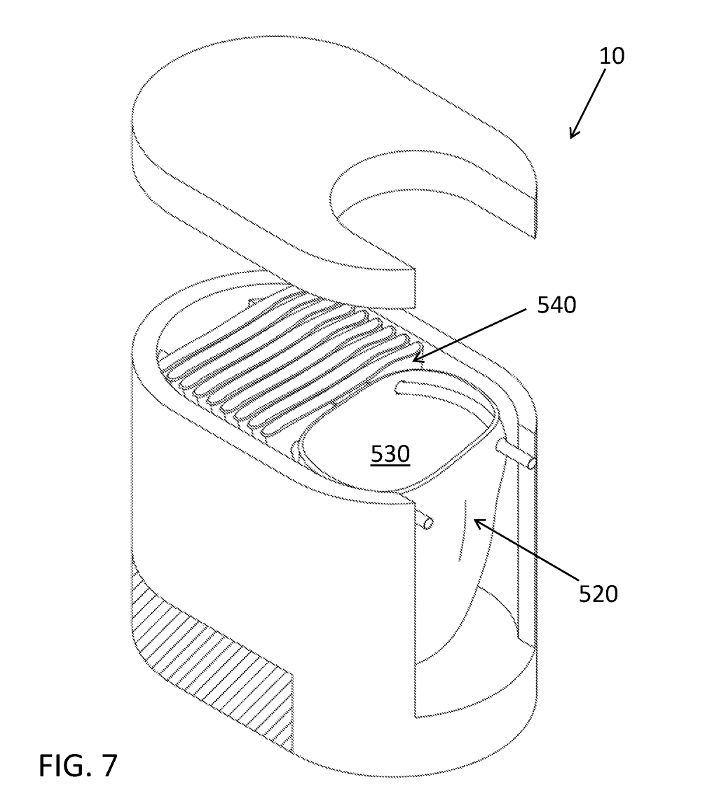

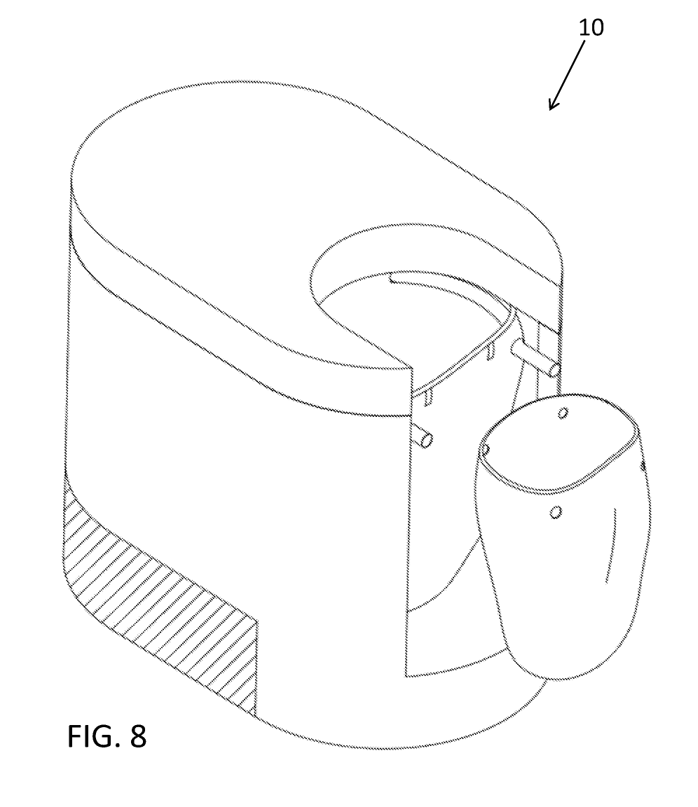

The method for using the animal foot cover dispenser and animal foot cover system 10, as shown in FIGS. 5-8, operates first by the user inserting a plurality of animal foot covers 300 into the animal foot cover dispenser 100 by guiding the animal foot covers 300 onto the impedance structure portion 230 of the plurality of rail members 220, past the impedance structure 230, and towards the elongated portion 270 of the rail members 220. In another embodiment, as shown in FIGS. 5A-D, the plurality of rail members 220 may be uncoupled from the dispenser enclosure 110, the animal foot covers 300 guided onto the elongated portion 270 of the rail members 220, and the rail members 220 and animal foot covers 300 recoupled to the enclosure 110. Once inserted, the animal foot covers 300 are retained therein by the impedance structure 230 of each of the rail members 220. As shown in FIGS. 6-8, the user then primes the dispenser 100 by pulling a first cover 520 towards the impedance structure portion 230 of the rail members 220, causing the animal foot cover opening 530 of the first cover 520 to expand to, and coincide with, the foot acceptance area 240 formed by the impedance structures 230, which retains the animal foot cover 520 in place (as shown in FIG. 7). The user then inserts an animal foot through the animal foot receiving opening 140 of the dispenser 100, simultaneously passing the animal foot through the foot acceptance area 240 and opening 530 of the first animal foot cover 520. After insertion, the now covered animal foot is removed by the user through the animal foot dispensing opening 150 of the dispenser 100, thereby also pulling and removing the first cover 520 with it. In removing the covered animal foot from the dispenser 100, the coupling material 340 coupling the first animal foot cover 520 to a second animal foot cover 540 transfers a sufficient force to load the second animal foot cover 540 into place, aligning the opening of the second animal foot cover 540 with the foot acceptance area 240 formed by the impedance structures 230. The impedance structures 230 will confine the subsequent animal foot cover 540 enabling the uncoupling of the first animal foot cover and continued removal of the animal foot and first animal foot cover 520 from the dispenser 100. The complete removal and uncoupling of the recently covered animal foot would then result in the dispenser 100 being primed and ready for the next dispensing use, as shown in FIG. 8. The aforementioned process would then be repeated as many times as the user desired, limited by the number of animal foot covers 300 loaded into the dispenser 100.

Those of ordinary skill in the art will understand and appreciate the foregoing description of the invention has been made with reference to certain exemplary embodiments of the invention, which describe an animal foot cover dispenser. Those of skill in the art will understand that obvious variations in construction, material, dimensions or properties may be made without departing from the scope of the invention which is intended to be limited only by the claims appended hereto.

What is claimed is:

1. An animal foot cover dispenser, comprising:
a. a cover dispenser enclosure having an animal foot receiving opening and an animal foot dispensing opening;
b. a plurality of rail members coupled to the cover dispenser enclosure;
c. each rail member of the plurality of rail members having an elongated portion configured to guide and retain animal foot covers and an impedance portion joined to the elongated portion, configured in one state to confine the animal foot covers to the elongated portion and configured in a second state to stage the animal foot covers and release the animal foot covers; and
d. the plurality of rail members positioned such that the impedance portion of each rail member form a foot acceptance opening that aligns with the animal foot receiving opening and a foot release opening that aligns with the animal foot dispensing opening.

2. The animal foot cover dispenser of claim 1, wherein the plurality of rail members are removably coupled to the cover dispenser enclosure.

3. The animal foot cover dispenser of claim 1, wherein the animal foot receiving opening and animal foot dispensing opening align to form a continuous opening.

4. The animal foot cover dispenser of claim 1, wherein each of the plurality of rail members further comprises a retention member movably coupled to an end, each retention member further configured to retain animal foot covers within the cover dispenser enclosure.

5. The animal foot cover dispenser of claim 4, wherein the retention member further comprises a spring-loaded mechanism configured to allow removal of a covered animal foot through exertion of a sufficient force.

6. The animal foot cover dispenser of claim 1, wherein a top surface of the cover dispenser enclosure is a lid member coupled to the cover dispenser enclosure.

7. The animal foot cover dispenser of claim 6, wherein the lid member further comprises a lid opening that is the animal foot receiving opening.

8. The animal foot cover dispenser of claim 1, wherein the foot cover dispenser enclosure comprises at least one exterior surface having at least one ergonomic surface feature configured to facilitate hand-held use.

9. The animal foot cover dispenser of claim 1, wherein the foot cover dispenser enclosure comprises at least one exterior surface having an enhanced frictional finish configured to facilitate surface grip.

10. The animal foot cover dispenser of claim 1, further comprising a removable stand coupled to the cover dispenser enclosure.

11. An animal foot cover dispenser system, comprising:
a. a cover dispenser enclosure having an animal foot receiving opening and an animal foot dispensing opening;
b. a plurality of rail members coupled to the cover dispenser enclosure;
c. each rail member of the plurality of rail members having an elongated portion configured to guide and retain animal foot covers and an impedance portion joined to the elongated portion, configured in one state to confine the animal foot covers to the elongated portion and configured in a second state to stage the animal foot covers and release the animal foot covers;
d. the plurality of rail members positioned such that the impedance portions of each rail member form a foot acceptance opening that aligns with the animal foot receiving opening and a foot release opening that aligns with the animal foot dispensing opening; and
e. at least one animal foot cover coupled to the plurality of rail members.

12. The animal foot cover dispenser system of claim 11, wherein the plurality of rail members are removably coupled to the cover dispenser enclosure.

13. The animal foot cover dispenser system of claim 11, wherein the animal foot cover further comprises at least one continuous surface.

14. The animal foot cover dispenser system of claim 13, wherein the animal foot cover further comprises at least one first opening configured to receive an animal foot.

15. The animal foot cover dispenser system of claim 14, wherein the animal foot cover further comprises a plurality of openings through the continuous surface to facilitate loading and retention of the animal foot covers within the dispenser.

16. The animal foot cover dispenser system of claim 15, wherein the animal foot cover further comprises a plurality of material configured to couple a first animal foot cover to a second animal foot cover.

17. The animal foot cover dispenser system of claim 16, wherein the animal foot cover further comprises a fastening mechanism disposed about the first opening and configured to couple the animal foot cover to an animal's foot.

18. The animal foot cover dispenser system of claim 17, wherein the continuous surface of the animal foot cover further comprises a means to remove the foot cover from the animal's foot.

19. A method of covering an animal foot, comprising:
a. inserting the animal foot into a foot receiving opening of a foot cover dispenser with a plurality of rail members that has been loaded and primed with animal foot covers;
b. inserting the animal foot into an opening of a first animal foot cover disposed within the foot cover dispenser;
c. exerting a force on both the animal foot and first animal foot cover that is sufficient to overcome a retention force of a retention member of the foot cover dispenser;
d. removing the animal foot and animal foot cover from the foot cover dispenser while exerting a sufficient force to facilitate uncoupling the first animal foot cover from a second animal foot cover; and
e. exerting a sufficient force to reprime the foot cover dispenser by moving the second animal foot cover into a previous position of the first animal foot cover and aligned with a foot cover staging area of the foot cover dispenser.

20. The method of claim 19, further comprising the steps of:
a. removing the plurality of rail members from the foot cover dispenser;
b. guiding the animal foot covers onto the plurality of rail members; and
c. recoupling the plurality of rail members to the foot cover dispenser.
